(19) United States
(12) Patent Application Publication
(10) Pub. No.: US 2005/0157514 A1
(43) Pub. Date: Jul. 21, 2005

(54) Light structure

(75) Inventor: Dirk Brinkmann, Wiernsheim (DE)

Correspondence Address: CROWELL & MORING LLP;INTELLECTUAL PROPERTY GROUP, P.O. BOX 14300, WASHINGTON, DC, 20044-4300, US

(73) Assignee: Dr. Ing. h.c.F. Porsche AG, Weissach (DE)

(21) Appl. No.: 11/013,885

(22) Filed: Dec. 17, 2004

(30) Foreign Application Priority Data
Dec. 19, 2003 (DE) DE 10359748.4-54

(51) Int. Cl. B60Q 1/00

(52) U.S. Cl. 362/547

(57) ABSTRACT

An illuminating device, particularly for motor vehicles, is suggested which has a housing, and a lens which form the interior space of a headlight. In addition to reflectors and lights, a component 15 is provided in the interior space of the headlight, which component 15 is arranged on the housing of the headlight and which has a heat-sensitive expansion element 16 and a valve 17, in which case the expansion element opens the valve when a defined temperature has been reached for the aerating of the interior space of the headlight. In addition, a moisture-absorbing material is arranged in the interior space of the headlight, which material absorbs the moisture in the headlight at low temperatures and thus when the valve is closed.

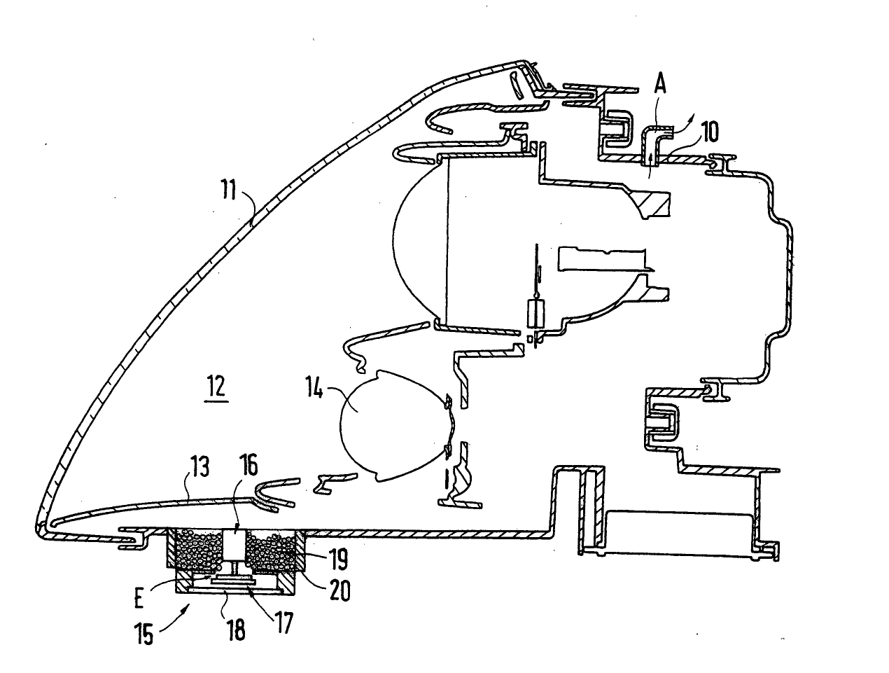

This application claims the priority of German Patent Application No. DE 10359748.4-54, filed Dec. 19, 2003, the entire disclosure of which is expressly incorporated by reference herein.

### BACKGROUND AND SUMMARY OF THE INVENTION

The invention relates to an illuminating device, particularly for motor vehicles, as known, for example, from German Patent Document DE 32 20 704 C2. Such an illuminating device consists at least of a glass pane or a plastic pane, a housing and a reflector which together form the interior space of a headlight. For ventilating and deventilating this interior space, it is known from the prior art to provide a ventilating duct at the lower housing edge and a deventilating duct at the upper housing edge, which are integrated in the headlight fastening and are constructed as a labyrinth seal.

The ventilating and deventilating of the interior space of illuminating devices, particularly of headlights, is necessary in order to prevent the precipitating of condensation water on the interior side of the pane. Such a condensate formation leads to an impression of lower quality and to complaints by customers. A formation of condensate in the interior space of the headlight impairs the appearance of the headlight.

Simultaneously with the implementation of a ventilation and deventilation of the interior space of the headlight, it is endeavored to ensure that no unnecessary moisture enters into the headlight through these ducts.

The arrangement according to the invention has the advantage that, as a result of the placing of a moisture-absorbing material in the interior space of the headlight, the moisture situated in the interior of the headlight, can be absorbed by this medium, and a condensate formation is avoided. It is another advantage that additionally a valve is provided which is controlled as a function of climatic conditions, and that, when a defined temperature, a defined temperature course, a defined air moisture and/or a defined course of the air moisture has/have been reached, this valve opens for aerating the interior space of the headlight. As a result of this ventilation of the headlight, the moisture-absorbing material, in turn, is simultaneously dried, and the moisture from the headlight is emitted to the environment by way of an opening in the upper area of the headlight.

Additional advantageous improvements of the arrangement according to the invention are provided by the measures indicated in the subclaims.

The valve can advantageously be operated by an expansion element, by a bimetal, electromagnetically or electromotively. Here, the possibility of a heat-sensitive expansion element will be described which, starting at a definable temperature, expands to such an extent that the valve is opened.

It was found that particularly porous SiO₂ is suitable for use as the moisture-absorbing material, and that it is advantageous to arrange the moisture-absorbing material preferably in the proximity of the coldest zone of the illuminating device.

It is also advantageous for the valve, the expansion element and preferably also the moisture-absorbing material to be integrated in an integral module. In this manner, they can be inserted as a compact module during the manufacturing of the headlight into an opening provided for this purpose.

Other objects, advantages and novel features of the present invention will become apparent from the following detailed description of the invention when considered in conjunction with the accompanying drawings.

### BRIEF DESCRIPTION OF THE DRAWINGS

The FIGURE is a basic diagram of a headlight for motor vehicles with the arrangement of the component made of moisture-absorbing material and the valve arrangement.

### DETAILED DESCRIPTION OF THE DRAWING

In the FIGURE, the housing of the headlight has the reference number 10 and the lens has the reference number 11.

These two components comprise the interior 12 of the headlight. In the case of modern headlights, several lights and reflectors are normally provided in the interior space of this illuminating device, so that high-beam lights, low-beam lights and possibly also fog lights and/or cornering lights are arranged in the headlight.

For reasons of simplicity, symbolically only one reflector in the headlight has the reference number 13 and one lamp in the headlight has the reference number 14. In the lower area of the headlight, a component 15 is arranged in the base plate of the headlight. This component 15 consists of an expansion element 16 which is arranged in the center and which is connected with a valve 17. The expansion element 16 is conceived such that, starting at a temperature of approximately 50° C., it opens the valve 17 as a result of its expansion, whereby an opening E is obtained. However, it is conceivable to also here detect the temperature course and/or the moisture in the headlight. In the upper area of the headlight, an opening A is provided so that, when the valve 17 is opened, an aeration of the headlight takes place from the resulting opening E to the opening A. In addition to the expansion element, the component 15 has a moisture-absorbing material 19, and has a membrane 18 on its side facing away from the headlight, in which case a filter-type arrangement can also be provided here. The membrane 18 is not airtight and closes off the headlight against the penetration of dirt in the event that the valve 17 is opened.

The above-described arrangement has the following method of operation. In the low temperature range, preferably at temperatures up to 50° C., the moisture-absorbing material 19 absorbs the moisture in the headlight which is formed as a result of the heating by means of the lights, whereby a formation of condensation water in the headlight is avoided. At high temperatures, when also the absorption capacity of the moisture absorbing material is exhausted, the valves 17 opens as a result of the expansion of the expansion element, and the headlight is aerated by way of the openings E and A. In this case, the moisture-absorbing material is simultaneously dried, so that it can again absorb moisture.

As illustrated in the FIGURE, the component 15 can be preassembled as an integral component and can then be inserted into a corresponding opening in the housing bottom or, as an alternative to a conventional air inlet opening of the headlight.

However, it is also conceivable that the component 15 consists only of the expansion element 16, the valve 17 and the membrane 18 which are arranged in a housing 20, and the moisture-absorbing material 19 is arranged in the direct proximity of the opening E forming when a heating takes place above a defined temperature. It should only be placed in such a manner that, when the headlight is aerated from opening E to opening A, a good drying of the moisture-absorbing material is achieved.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. An illuminating device comprising:
a housing and a lens which form an interior space of a headlight;
at least on reflector and at least one light provided in the interior space;
a component in contact with the interior space, said component including a valve controlled as a function of climatic conditions, wherein when at least one of defined temperature, a defined temperature course, a defined air moisture and a defined air moisture course has been reached, the valve opens to aerating the interior space of the headlight, said component further including a moisture-absorbing material arranged in the interior space of the headlight.

2. Illuminating device according to claim 1, wherein the
valve is operated by one of an expansion element, a bimetal, electromagnetically and electromotively.

3. Illuminating device according to claim 1, wherein
the moisture-absorbing material is arranged in the proximity of a coldest zone of the illuminating device.

4. Illuminating device according to claim 1, wherein
the moisture-absorbing material is porous SiO₂.

5. Illuminating device according to claim 1, wherein
the moisture-absorbing material absorbs moisture forming in the headlight until the valve opens and, when the valve is open, releases it again during aerating of the headlight.

6. Illuminating device according to claim 1, wherein
the component has a membrane or a filter on its exterior side facing away from the headlight.

7. Illuminating device according to claim 2, wherein
the moisture-absorbing material is porous SiO₂.

8. Illuminating device according to claim 3, wherein
the moisture-absorbing material is porous SiO₂.

9. An illuminating device, comprising:
a housing and a lens forming an interior space;
at least one reflector and at least one light provided in said interior space;
a valve structure in contact with said interior space, said valve structure including a valve and a control device for controlling said valve as a function of climatic conditions.

10. The illuminating device according to claim 9 wherein said control device functions to open said valve to aerate said interior space in response to at least one of a defined temperature, a defined temperature course, a defined air moisture and a defined air moisture course.

11. The illuminating device according to claim 9 further including a moisture-absorbing material arranged in the interior space.

12. Illuminating device according to claim 10 further including a moisture-absorbing material arranged in the interior space.

13. Illuminating device according to claim 9 wherein said housing and lens formed the interior space of a headlight.

14. Illuminating device according to claim 10 wherein said housing and lens formed the interior space of a headlight.

15. Illuminating device according to claim 9 wherein the valve is operative by one of an expansion element, a bimetal, electromagnetically and electromotively.

16. Illuminating device according to claim 10 wherein the valve is operative by one of an expansion element, a bimetal, electromagnetically and electromotively.

17. Illuminating device according to claim 11, wherein
the moisture-absorbing material is porous SiO₂.

18. Illuminating device according to claim 11, wherein
the moisture-absorbing material absorbs moisture forming in the headlight until the valve opens and, when the valve is open, releases it again during aerating of the headlight.

19. Illuminating device according to claim 11, wherein
the component has a membrane or a filter on its exterior side facing away from the headlight.

20. Illuminating device according to claim 9, wherein
the component has a membrane or a filter on its exterior side facing away from the headlight.
